(19) United States
(12) Patent Application Publication
(10) Pub. No.: US 2023/0177429 A1
(43) Pub. Date: Jun. 8, 2023

(54) INTERACTIVE OPTION PLAN ADJUSTMENT BASED ON DYNAMIC RULES

(71) Applicant: International Business Machines Corporation, Armonk, NY (US)

(72) Inventors: Kushagra Manglik, Lucknow (IN); Satyam Dwivedi, Bangalore (IN); Vijay Ekambaram, Chennai (IN); Nupur Aggarwal, Bangalore (IN)

(21) Appl. No.: 17/545,684

(22) Filed: Dec. 8, 2021

(51) Int. Cl. G06Q 10/06; G06Q 30/02

(52) U.S. Cl. CPC G06Q 10/06315; G06Q 30/0205

(57) ABSTRACT

A method comprises receiving as input one or more spatial temporal factors associated with one or more products where the one or more spatial temporal factors affect a demand for one or more product attributes of the one or more products at one or more locations at a select period of time and dynamically modifying a first option plan based on the received input of the one or more spatial temporal factors to generate a second option plan for a given location of the one or more locations at the select period of time. The steps are performed by at least one processor device coupled to a memory.

### BACKGROUND

Business option planning refers to the planning by an entity for the manufacture and/or distribution of products and/or services during a particular time period including seasonal or calendar periods. Option planning is typically based on historical data and trends tracked by the entity for an identified time period and within a geographical location. However, current option planning has several significant drawbacks, as will be further detailed herein.

### SUMMARY

Accordingly, the present disclosure obviates the disadvantages of existing option planning methodologies by providing interactive option adjustment based on dynamic rules.

In one illustrative embodiment, a method comprises receiving as input one or more spatial temporal factors associated with one or more products where the one or more spatial temporal factors affect a demand for one or more product attributes of the one or more products at one or more locations at a select period of time and dynamically modifying a first option plan based on the received input of the one or more spatial temporal factors to generate a second option plan for a given location of the one or more locations at the select period of time. The steps are performed by at least one processor device coupled to a memory.

In another illustrative embodiment, an apparatus comprising a memory and a processor operatively coupled to the memory is configured to implement the steps of receiving as input one or more spatial temporal factors associated with one or more products where the one or more spatial temporal factors affect a demand for one or more product attributes of the one or more products at one or more locations at a select period of time and dynamically modifying a first option plan based on the received input of the one or more spatial temporal factors to generate a second option plan for a given location of the one or more locations at the select period of time.

In yet another illustrative embodiment, a computer program product is provided. The computer program product comprises a non-transitory computer readable storage medium for storing computer readable program code which, when executed, causes a computer to receive as input one or more spatial temporal factors associated with one or more products where the one or more spatial temporal factors affect a demand for one or more product attributes of the one or more products at one or more locations at a select period of time and dynamically modify a first option plan based on the received input of the one or more spatial temporal factors to generate a second option plan for a given location of the one or more locations at the select period of time.

Other embodiments will be described in the following detailed description of embodiments, which is to be read in conjunction with the accompanying figures.

### BRIEF DESCRIPTION OF THE DRAWINGS

FIG. 1 is a generalized flow chart depicting the system and methodology for implementing the interactive business option plan according to one or more illustrative embodiments.

FIG. 2 is a graphical illustration of an architecture for implementing the interactive business option plan associated with the flow chart of FIG. 1 according to one or more illustrative embodiments.

FIG. 3 is a flow chart further detailing the system and methodology for implementing the interactive business option plan according to one or more illustrative embodiments.

FIG. 4 is a graphical representation illustrating utility vectors generated by a location-attribute affinity module utilized for implementing the interactive business option plan according to one or more illustrative embodiments.

FIG. 5 is an exemplative cosine similarity matrix indicating expected footfall distribution for different locations generated by an attribute correlation module according to one or more illustrative embodiments.

FIG. 6 is an exemplative data structure generated by the attribute correlation module for implementing the interactive business option plan according to one or more illustrative embodiments.

FIG. 7 is a graphical representation generated by the attribute correlation module for implementing the interactive business option plan according to one or more illustrative embodiments.

FIG. 8 is a system diagram of an exemplary computer system on which at least one or more illustrative embodiments can be implemented.

FIG. 9 depicts a cloud computing environment according to one or more illustrative embodiments.

FIG. 10 depicts abstraction model layers according to one or more illustrative embodiments.

### DETAILED DESCRIPTION

Illustrative embodiments of the present disclosure relate to business planning, and, more particularly, relate to a system and methodology for dynamically adjusting an attribute-based business plan to facilitate manufacture and/or distribution of products in accordance with actively predicted spatial temporal data. More specifically, one or more illustrative embodiments described herein are directed to a system and methodology capable of incorporating various run-time spatial temporal factors such as footfall variations, consumer transit across various locations, trend changes including product design changes, business constraints, etc., which could affect the existing option plan, and permit interactive fine-tuning of the existing option plan based on a conditioned ranking of individual product attribute popularities and correlations in association with the identified spatial temporal factors. Moreover, in illustrative embodiments, the proposed system will initiate the discovery or tracking of various spatial temporal factors which could alter the demand of an entity's products and various other attributes in an existing business option plan. By way of example, and without limitation, spatial temporal factors include i) events occurring across or within various geographical locations causing consumer transit across these locations; ii) recent trends or changes in social media such as in Facebook, Instagram, Twitter etc., which could alter the demand of product attributes and designs; and iii) business constraints such as the availability of a particular product attribute, various cost changes in the product and manufacture and distribution constraints.

In illustrative embodiments, the present disclosure enables the modelling of one or more changes or shifts in consumer demand with respect to these various spatial and temporal factors based on the ranking of individual product attribute popularities and correlations. The proposed system incorporates an interactive user interface (UI) enabling the user to select one or more identified spatial or temporal factors for fine-tuning the option plan. In one or more illustrative embodiments, fine tuning of the existing business option plan may be performed at multiple locations based on predicted demand distribution of attributes by considering user defined constraints, product cannibalization and halo effects in sales of the entity's products. Moreover, the present disclosure determines a computation of product and/or service demand based on historical sales data while enabling dynamic or multiple time relatively light weight adjustments using dynamic real time inputs.

Illustrative embodiments of the present disclosure overcome issues with conventional business option plan methodologies which are ineffective in dynamically capturing and considering real time spatial temporal data, such as sporadic or temporary movement of consumers across various geographical locations for events or occasions, footfall variations, trending features, and other business constraints. As a consequence, the inability to track and dynamically incorporate this consumer activity into the business option plan results in lost sales opportunities and growth. Furthermore, conventional option plan methodologies are incapable of dynamically accepting user input, and utilizing the input to tailor the option plan to the user's needs.

In the following discussion, the term “business option plan” (or, more generally, option plan) includes, without limitation, an entity's plan for manufacturing and/or distribution of products and/or services for subsequent periodic or seasonal release where the plan contains information about the distribution of the attributes across products, quantities for each product, etc. The term “attribute” includes, without limitation, one or more characteristics associated with an item of an entity or sub-entity. An “item” as used herein illustratively refers to one or more products, one or more services, and one of more combinations thereof. With respect to an item in the form of a product, the “attributes” may include, without limitation, size, color, design features, design changes, materials, cost, weight or any other characteristic associated with the product.

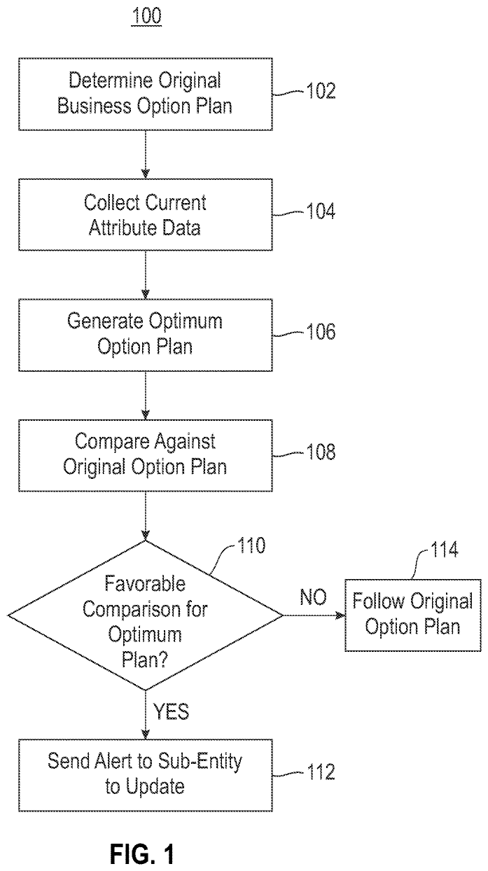

Referring now to FIG. 1, a general flow chart 100 of the system and method for optimizing a business option plan is illustrated. In illustrative embodiments, the flow chart may be implemented for one or more sub-entities of the enterprise on an individual and/or a collective basis. More specifically, the generalized methodology and system depicted in the flow chart 100 of FIG. 1 may be tailored to any targeted sub-entity of an enterprise for a designated time period, i.e., it is not necessarily a generic plan for all sub-entities or a subgroup of the sub-entities. At step 102, an original business option plan for at least one sub-entity of an enterprise is developed. The first or existing option plan is initially generated by the enterprise. The business option plan details specifics including, for example, information and instructions associated with the manufacture and distribution of one or more services or goods for a particular geographical region for a specific time period, e.g., a seasonal time period. The business option plan is generally based on historical data collected from numerous sources within one or more geographical locations over targeted or predetermined time periods, for example, seasonal time periods (historical spatial temporal data) and stored in one or more historical databases. The historical spatial temporal data may be collected via conventional data collection processes by sub-entities within targeted geographical regions. The original option plan is generated by one or more predictive analytics processes applied to the historical spatial temporal data stored in the one or more historical databases. By way of example, predictive analytics contemplated for generating the business option plan include predictive modeling, descriptive modeling and decision-making modeling.

With continued reference to FIG. 1, at step 104, current attribute data associated with one or more attributes of services or goods are tracked and identified. The current attribute data may be collected and stored by one or more computer systems associated with the sub-entity utilizing data mining processes known in the art. Exemplative attribute data of interest include, without limitation, expected “footfall” type data and social media data. Footfall data may include current transportation data such as recent purchases or reservations of airline, train, bus tickets or any other acquisition of public and/or private transportation by potential consumers. Additional footfall data includes the occurrence of one or more events including sports events, political events or any other entertainment-type event occurring in the identified geographical region. Social media data may include: i) any of the aforementioned social platforms such as including Facebook®, Instagram®, and/or Twitter®; ii) current sales data or trends associated with the one or more services or goods; and iii) impact associated with a celebrity or person of interest entering a determined geographical area and/or promoting the one or more goods or services through advertisement or actual use (e.g., wearing the identified goods or merchandise of the enterprise).

In step 106, the current attribute data is subjected to one or more predictive analytic processes including those processes and algorithms identified hereinabove. In illustrative embodiments, the one or more analytics processes are associated with an option plan engine or module which receives the updated trends, footfall data and other current spatial temporal data, and generates an optimum option plan based on the new data. In illustrative embodiments, the optimum option plan is specific to a particular geographical of interest or sub-entity of the enterprise.

In step 108, a comparison module compares the generated optimum option plan against the original option plan. In the event the comparison module determines a favorable comparison (step 110) or the potential for a net increase in revenue in the sale of the one or more goods or services (identified “YES” in the flowchart), the sub-entity is notified (step 112) and the optimum option plan is implemented. In the event that no or minimal gain is calculated by the comparison module (identified “NO” in the flowchart), the original option plan is maintained and followed. (Step 114).

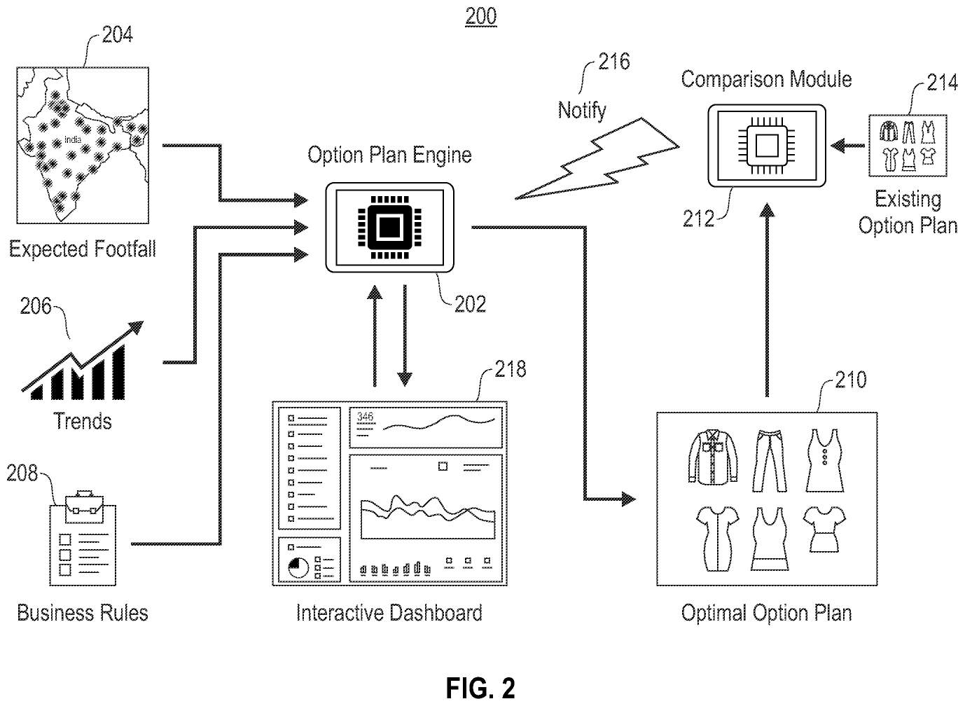

Referring now to FIG. 2, one illustrative embodiment of an architecture associated with implementing the interactive business option plan associated with the flow chart of FIG. 1 is illustrated. The architecture 200 includes the option plan engine 202 described in connection with step 106 of the flow chart of FIG. 1 which receives input in the form of current or dynamic spatial temporal data associated with the one or more goods and services. More specifically, the input includes footfall data 204 and trend data 206 which is also described in connection with step 106 of the flow chart 100 of FIG. 1. The input further includes one or more sets of business rules 208. The business rules data 208 may be any set of instruction or regulations concerning the one or more goods and services. For example, and without limitation, the business rules 208 may include branding instructions associated with the one or more goods and services, legal criteria such as rules, regulations or legal constraints and monetary criteria (including, e.g., budgetary limitations) associated with the one or more goods and services. The option plan engine 202 receives the input and, via one or more predictive analytics algorithms associated with the option plan engine 202, generates a second or optimal option plan 210. The predictive analytics may include any suitable predictive modeling, descriptive modeling, and decision-making modeling/algorithms or the like. The architecture further includes a comparison module 212 having one or more algorithms for comparing the optimal option plan 210 generated by the option plan engine 202 against the original or existing option plan 214. The existing option plan 214 and the optimal option plan 210 are received as input to the comparison module 212. The comparison module 212 generates an output which, in illustrative embodiments, is in the form of a notification 216 to the option plan engine 202 indicating results of the comparison of the two plans. The results may include an identification of savings, profits, instructions or other attributes associated with the generated optimal option plan. In some illustrative embodiments, the optimal option plan may not identify any benefit compared to the existing option plan.

Referring still to FIG. 2, the architecture 200 further includes an interactive dashboard or interface 218 in communication with the option plan engine 202. The interactive interface 218 permits a user to fine-tune, change or modify attributes of the generated optimal option plan 210 and/or attributes associated with the footfall data 204, trend data 206 and/or business rules data 208. In illustrative embodiments, the user may modify input data 204, 206, 208 prior to generation of the optimal option plan 210 or subsequent to generation of the optimal option plan 210. In illustrative embodiments, it is envisioned that the user may alter one or more parameters or attributes associated with the generated optimal option plan. The option plan engine 202 can be re-executed with the changed parameters to generate at least one or more additional optimal option plans 210 to view the impact of the changed parameters relative to the existing option plan and/or any prior generated optimal option plan 210. Moreover, the interactive interface 218 enables the user to change parameters of the input data and/or parameters associated with the generated optimal option plan(s) 210 to determine the impact these changes have on a subsequent generated optimal option plan relative to a prior optimal option plan or the original option plan. The interactive interface may include a video screen and/or an input in the form of a keypad or touch screen.

Further details of the architecture 200 will be provided hereinbelow.

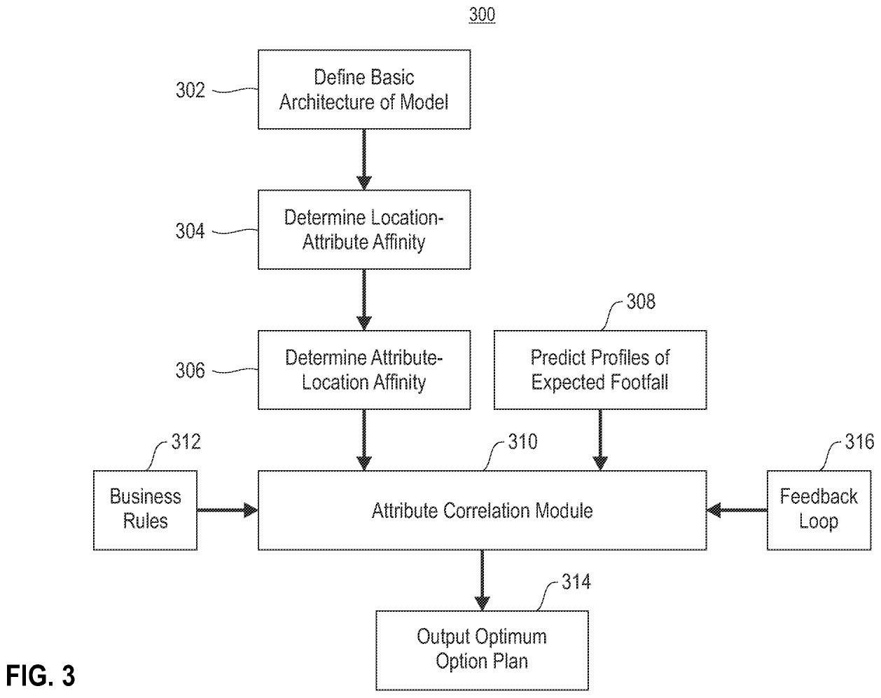

FIG. 3 is a flow chart 300 depicting one illustrative embodiment of the interactive business option plan of the present disclosure.

### Define Basic Architecture

At step 302, a basic architecture of a model is generated. The basic architecture can be represented as a matrix which is represented by Matrix 1 provided hereinbelow:

MATRIX 1

| | L₁ | L₂ | L₃ | L₄ | L₅ |
|---|---|---|---|---|---|
| f₁1 | 10 | 20 | 5 | 50 | 34 |
| f₁2 | 31 | 5 | ⊙ | 4 | ⊙ |
| f₁3 | ⊙ | 23 | ⊙ | 43 | ⊙ |
| f₁4 | 0 | ⊙ | 12 | 11 | 2 |
| f₁5 | ⊙ | 3 | 45 | 5 | 45 |
| f₁6 | 3 | 61 | ⊙ | 42 | ⊙ |

where:
a) the rows of the matrix X denote the set of attribute values V for a particular attribute ‘fᵢ’ in this example, ‘fᵢ’, under consideration = {f₁1, f₁2, f₁3, f₁4, f₁5, f₁6 . . . . . . f₁N};
b) the columns of the matrix X denote the set of L locations/regions Lₐ under consideration = {L₁, L₂, L₃, L₄, L₅, . . . . . . L_{N}};
c) the number in each cell represents a value Vₘ associated with the particular attribute ‘fᵢ’ at the particular location Lₐ where, in illustrative embodiments, the value may be the number of units sold;
d) the indicator ⊙ in a cell (i, z) indicates that particular attribute value ‘f₁i’ is not carried at location ‘z’.

Based on the historical sales data, a matrix X is generated for each of the Y attributes which are denoted by set {f₁, f₂, f₃, f₄, f₅, f₆ . . . f_{y}}; Each matrix incorporates the different attribute values Vₘ for each attribute ‘fᵢ’ at each location Lₐ.

### Determine Location Attribute Affinity

The next step (step 304) in the process includes determining the relative preferences of different locations for the identified goods or services. In illustrative embodiments, an indicator vector ‘qₛ’ is utilized to indicate whether a product having a particular attribute ‘fᵢ’ is carried at a given location ‘s’ (in this example, L₁). The indicators “0” and “1” respectively indicate that the attribute value ‘fᵢ’ is, or is not, carried by the product at the given location ‘s’ (L₁). Therefore, the probability that a product has a particular attribute value at location ‘s’ can be represented as P(jᵢQₛ), e.g., the probability that a product sold at location Lₐ has vector Qₛ. The probability P(j/Qₛ) may be expressed as a function which is parametrized by μjs, i.e., the demand for attribute value ‘j’ in location ‘s’. The demand μjs is further modelled by an attribute affinity vector βj which captures the affinity of an attribute value ‘j’ to different locations. One representative attribute affinity vector βⱼ is represented by the following table:

βⱼ vector

| Location | L₁ | L₂ | L₃ | L₄ | . . . | L_{N} |
|---|---|---|---|---|---|---|
| Attribute | 0.3 | 0.5 | 0.2 | 0.8 | . . . | 0.7 |
| Value | | | | | | |

Thus, the probability P(jᵢQₛ) is represented by the following formula:

$$P ( j \vert {q}_{s} ) = \frac{{e}^{{μ}_{js}}}{{Σ}_{j ∈ {q}_{s}} {e}^{{μ}_{j s}}}$$

where μⱼₛ={βⱼ Yₛ} and Yₛ is the vector, whose elements indicate expected footfall distribution from different locations ‘s’.

One representative Yₛ vector is represented as follows:

| Location | L₁ | L₂ | . . . . . . | L_{N} |
|---|---|---|---|---|
| Footfall | 5 | 2 | . . . . . . | 3 |
| Value | | | | |

### Determine Attribute-Location Affinity

The process is continued by determining the attribute-location affinity contribution. (Step 306). In illustrative embodiments, the log likelihood of total sales x for all feature values given indicator vector ‘qₛ’ for location ‘s’ is represented as:

L(x|qₛ)=log(Π_{jeq}_{ₛ}P(j|qₛ)^{x}^{ⱼₛ})

where xⱼₛ denotes the units of products sold with attribute value ‘j’ at location ‘s’ The equation is expanded as follows:

$$( x \vert {q}_{s} ) = {\sum }_{j ∈ {q}_{s}} {x}_{j s} [ {μ}_{j s} - log ( {\sum }_{j ∈ {q}_{s}} {e}^{{μ}_{j s}} ) ]$$

where xⱼₛ denotes the units of products sold with attribute value j at location s.

By summing over all the columns of the matrix, i.e., across all locations L_{N}, the following equation may be generated:

$$L = {\sum }_{{q}_{s}} {\sum }_{j ∈ {q}_{s}} {x}_{j s} [ 〈 {β}_{j} , {γ}_{s} 〉 - log ( {\sum }_{j ∈ {q}_{s}} {e}^{〈 {β}_{j} , {γ}_{s} 〉} ) ]$$

Thus, by taking the gradient of the log likelihood with respect to utility vector βⱼ for each of the attribute values spanning across different attribute buckets we get to know all the βⱼ.

The obtained attribute location-affinity vector βj is then adjusted to take into account the current trends. One way to update the βj is to take a weighted average of the obtained βj and attribute-location affinity from historical trends data. Trend-based attribute-location affinity vectors for all attributes ‘j’ are determined whereby:

β_{jL}^{trend}=Average trendiness score of attribute j at location L

| β_{jL}_{₁}^{trend} | β_{jL}_{₂}^{trend} | β_{jL}_{₃}^{trend} | β_{jL}_{₄}^{trend} | . . . | β_{jL}_{_{N}}^{trend} |
|---|---|---|---|---|---|
| L₁ | L₂ | L₃ | L₄ | . . . | L_{N} |

in which:

βⱼ^{new}=βⱼ+τⱼ^{trend}

where τ is the weight given to trend data which may, in illustrative embodiments, be a user defined parameter.

### Predicting Profiles of Expected Distribution of Footfall

Referring again to the flow chart of FIG. 3, one exemplative additional step (step 308) in the process includes predicting profiles of footfall distribution based on various parameters. As indicated hereinabove, footfall or footfall data may include current transportation data including public and/or private transportation data, sporting events, political events, etc. In illustrative embodiments, transportation data including ticket purchases along with targeted destinations may be obtained from one or more public or private databases, manually captured or the like. Footfall data may also be obtained via tracking, for example, one or more individuals or groups via computing devices including any “internet of things” device having including global positioning systems capabilities. The collected footfall data at the event location or Location Lₐ is modeled with the distribution obtained in the earlier steps or processes.

### Attribute Correlation Module

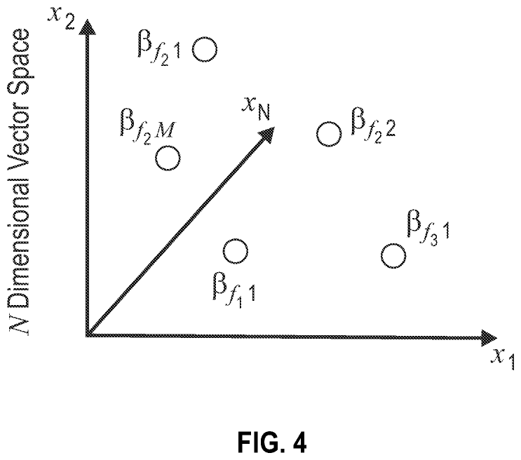

Referring again to the flow chart of FIG. 3, another exemplative additional step in the process is generating the attribute correlation module. (Step 310). With reference to the graphical representation of FIG. 4, initially each utility vector obtained from the location-attribute affinity module can be assumed to be a point in N dimensional (number of locations) vector space depicting the relative preference of different locations for each attribute value.

Expected footfall distribution from different locations at each of the Lₐ locations is determined and combined with the utility vectors for the different locations and attributes as input into the attribute correlation module. Rather than looking at the attribute values independently and recommending the top-ranked attribute value in each attribute class as an option plan, the subset of attribute values subject to one or more option plan constraints is determined such that the overall response of the entire attribute catalog towards the expected footfall is maximized.

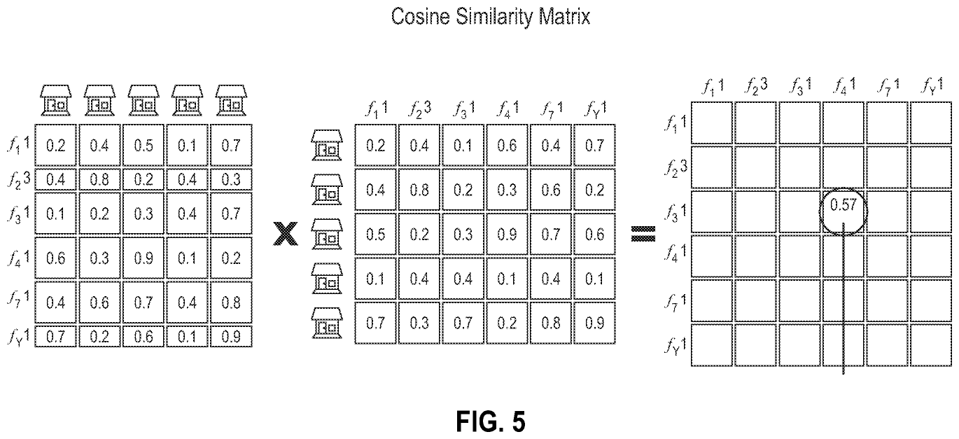

Thereafter, a cosine similarity matrix is generated. An exemplative similarity matrix is depicted in FIG. 5. In the first or left matrix, the rows of the matrix indicate the utility vectors of all the attribute values across all attribute buckets. The columns indicate the location's affinity for different attribute values. The middle matrix is a transposition of an adjacent matrix. The representative cell, 0.57, indicates the cosine similarity between attribute value f₃1 and f₄1.

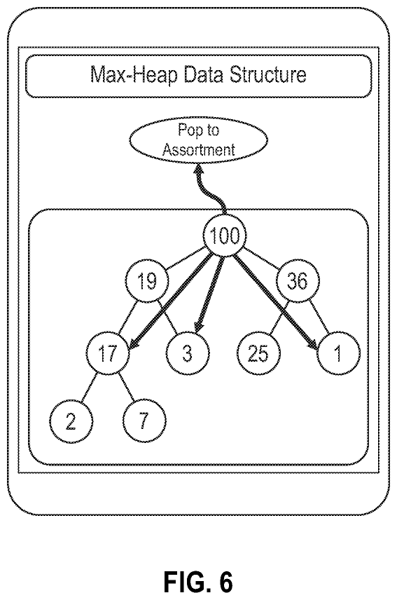

Once the cosine matrix is obtained, a MAX-Heap Data Structure or tree is generated. An exemplative MAX-HEAP Data Structure is illustrated in FIG. 6. The following factors are input into the MAX-HEAP Data Structure:
a) the expected footfall distribution from all locations at location ‘s’ are identified as γₛ.
b) the utility vectors for all attribute values spanning all attributes are calculated. Thus, Y number of sets are generated where each set is represented as {β_{f1}1, β_{f1}2, . . . β_{f1}m} and where the cardinality of each set can vary.
c) For each attribute value in each of the Y sets, the estimated demand μⱼₛ for that attribute value in location ‘s’ is determined using μⱼₛ=<βj,γₛ>.

A MAX-HEAP Data Structure is constructed using the μⱼₛ values for all attribute values.

### Business Rules

With reference again to FIG. 3, an option plan denoted by ‘α’ subject to all the business rules and constraints (step 312) is performed on the MAX-HEAP Data Structure. The following steps are implemented:

### Step 1

The root node from the MAX-HEAP Data Structure is extracted and appended to the option plan list denoted by α={f, . . . }.

### Step 2

The cosine similarity score between the extracted node's utility vector and the rest of the heap nodes' utility vectors from the cosine similarity matrix is/are obtained.

The demand, i.e., μⱼₛ for the rest of the heap nodes is updated or obtained by:
a) adding cosine similarity scores between the extracted node and the heap node if both belong to different attribute buckets; and
b) subtracting cosine similarity scores if both belong to same attribute bucket.

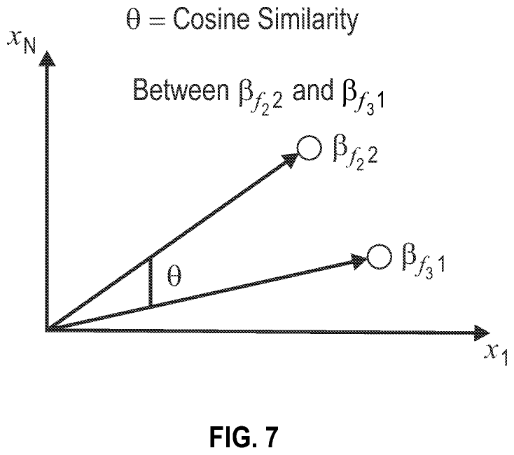

The above steps a and b are graphically represented in FIG. 7. The MAX-HEAP Data Structure may be updated based on the newly generated values.

### Output Optimum Option Plan

Rather than looking at the attribute values in silos and simply recommending the top-ranked attribute value in each attribute class as an option plan, the subset of attribute values subject to option plan constraints is determined such that the overall response of the entire attribute catalog towards the expected footfall gets maximized. The following illustration depicts a generated optimum option plan (step 314 of FIG. 3) fine-tuned for each location:
Location L₁ Location L₂ Location L₃ Location L_{N}
{f₁3, f₂4, . . . , f_{Y}4} {f₁1, f₂5, . . . f_{Y}3} {f₁2, f₂2, . . . f_{Y}1} {f₁4, f₂1, . . . f_{Y}4}

The generated option plans may be sent to the respective sub-entities associated with the locations.

### Feedback Loop

With reference again to FIG. 3, in illustrative and/or alternate embodiments, the observed in-season sales data may be observed to provide feedback (step 316) and update the trendiness score for the attributes. This trendiness score may be dynamically input into the option plan engine to update the attribute affinity distribution which skews the demand prediction (and hence the generated option plan) closer to the observed sales. Business constraint rules may be one of the inputs to the current system. If experts observe some unsatisfactory results in the option plan, new business rules may be added or modified to replace the original rules. Also, the system can also be extended to RL-reward schemes and policies which can generalize positive and negative reward intake and adapt accordingly. Feedback may be input via the interactive interface 218.

The aforedescribed methodology is exemplative of one illustrative embodiment of the present disclosure. It is noted that some of the steps may be combined or occur out of sequence than as presented herein.

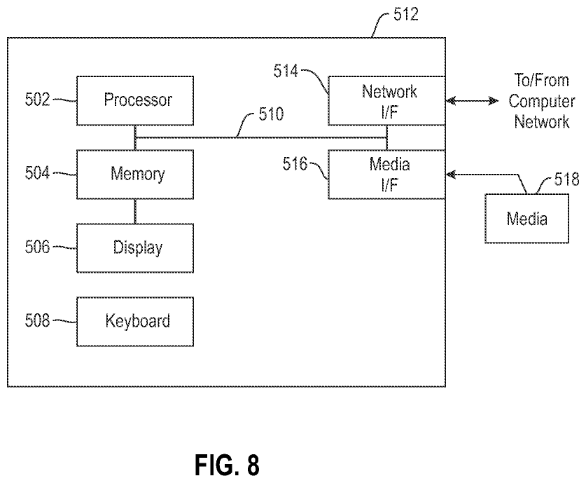

Additionally, an embodiment of the present disclosure can make use of software running on a computer or workstation. With reference to FIG. 8, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 8) running a server program. It will be understood that such a physical server may or may not include a display and keyboard.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present disclosure are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

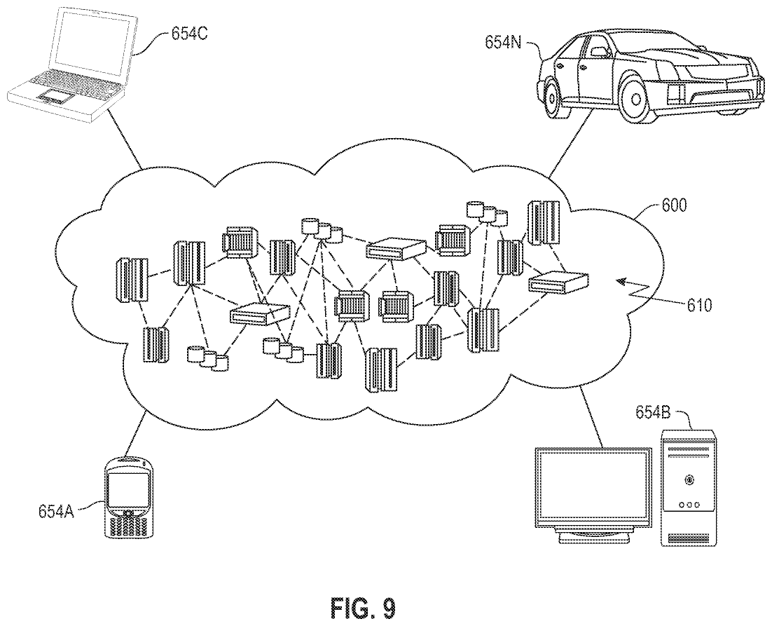

Referring now to FIG. 9, illustrative cloud computing environment 600 is depicted. As shown, cloud computing environment 600 includes one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 654A-N shown in FIG. 9 are intended to be illustrative only and that computing nodes 610 and cloud computing environment 600 can communicate with any type of computerized device over any type of network and/or network addressable connection (e.g., using a web browser).

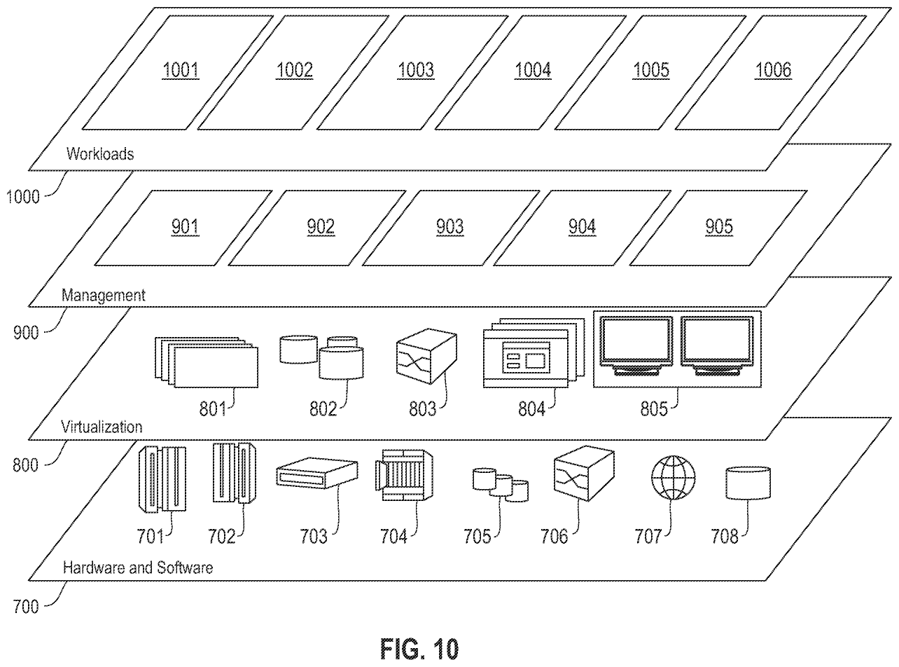

Referring now to FIG. 10, a set of functional abstraction layers provided by cloud computing environment 600 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 700 includes hardware and software components. Examples of hardware components include: mainframes 701; RISC (Reduced Instruction Set Computer) architecture based servers 702; servers 703; blade servers 704; storage devices 705; and networks and networking components 706. In some embodiments, software components include network application server software 707 and database software 708.

Virtualization layer 800 provides an abstraction layer from which the following examples of virtual entities may be provided: virtual servers 801; virtual storage 802; virtual networks 803, including virtual private networks; virtual applications and operating systems 804; and virtual clients 805. In one example, management layer 900 may provide the functions described below. Resource provisioning 901 provides dynamic procurement of computing resources and other resources that are utilized to perform tasks within the cloud computing environment. Metering and Pricing 902 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 903 provides access to the cloud computing environment for consumers and system administrators. Service level management 904 provides cloud computing resource allocation and management such that required service levels are met. Service Level Agreement (SLA) planning and fulfillment 905 provide pre-arrangement for, and procurement of, cloud computing resources for which a future requirement is anticipated in accordance with an SLA.

Workload layer 1000 provides examples of functionality for which the cloud computing environment may be utilized. Examples of workloads and functions which may be provided from this layer include: mapping and navigation 1001; software development and lifecycle management 1002; virtual classroom education delivery 1003; data analytics processing 1004; transaction processing 1005; and business option planning 1006, in accordance with the one or more embodiments of the present disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present disclosure may provide a beneficial effect such as, for example, automatically improving data annotations by processing annotation properties and user feedback.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving as input one or more spatial temporal factors associated with one or more products, the one or more spatial temporal factors affecting a demand for one or more product attributes of the one or more products at one or more locations at a select period of time; and
dynamically modifying a first option plan based on the received input of the one or more spatial temporal factors to generate a second option plan for a given location of the one or more locations at the select period of time;
wherein the steps are performed by at least one processor device coupled to a memory.

2. The method of claim 1 further including modelling demand at the given location for the one or more product attributes based on the received input.

3. The method of claim 2 enabling a user to adjust the generated second option plan through a user interface.

4. The method of claim 2 wherein the input includes at least one of expected footfall, trends and business rules associated with the one or more products.

5. The method of claim 4 wherein the expected footfall of the input includes migration data of one or more potential purchases of the one or more products relative to the given location of the one or more locations.

6. The method of claim 4 wherein the trends of the input include social media, sales data and upcoming events relative to the given location of the one or more locations.

7. The method of claim 4 wherein the trends of the input include one or more events occurring relative to the given location of the one or more locations.

8. The method of claim 1 further including comparing the second option plan to the first option plan.

9. The method of claim 8 including forwarding an alert to one or more users based on a favorable comparison of the second option plan to the first option plan.

10. The method of claim 4 including determining a probability that at least a given product of the one or more products at the given location of the one or more locations has a given attribute value.

11. The method of claim 10 including generating an attribute location-affinity vector for the given attribute value across the one or more locations.

12. The method of claim 11 including updating the attribute location vector based on trends associated with the one or more locations.

13. The method of claim 12 further including predicting profiles of expected distribution of footfall associated with the one or more products for the one or more locations.

14. An apparatus comprising:
a memory and a processor operatively coupled to the memory and configured to implement the steps of:
receiving as input one or more spatial temporal factors associated with one or more products, the one or more spatial temporal factors affecting a demand for one or more product attributes of the one or more products at one or more locations at a select period of time; and
dynamically modifying a first option plan based on the received input of the one or more spatial temporal factors to generate a second option plan for a given location of the one or more locations at the select period of time.

15. The apparatus of claim 14 wherein the processor is further configured to implement the step of:
modelling demand at the given location for the one or more product attributes based on the received input.

16. The apparatus of claim 15 wherein the processor is further configured to implement the step of:
enabling a user to adjust the generated second option plan through a user interface.

17. The apparatus of claim 14 wherein the input includes at least one of expected footfall, trends and business rules associated with the one or more products.

18. A computer program product comprising a non-transitory computer readable storage medium for storing computer readable program code which, when executed, causes a computer to:
receiving as input one or more spatial temporal factors associated with one or more products, the one or more spatial temporal factors affecting a demand for one or more product attributes of the one or more products at one or more locations at a select period of time; and
dynamically modifying a first option plan based on the received input of the one or more spatial temporal factors to generate a second option plan for a given location of the one or more locations at the select period of time.

19. The computer program product of claim 18 wherein the computer readable program code which, when executed, causes the computer to:
model demand at the given location for the one or more product attributes based on the received input.

20. The computer program product of claim 19 wherein the computer readable program code which, when executed, causes the computer to:
enable a user to adjust the generated second option plan through a user interface.
